(19) United States
(12) Patent Application Publication
(10) Pub. No.: US 2021/0368738 A1
(43) Pub. Date: Dec. 2, 2021

(54) A DEVICE AND METHOD FOR CONDITIONING AN ANIMAL

(71) Applicant: 4LEGSFIT PTY LTD, Arcadia, New South Wales (AU)

(72) Inventors: Allan Lester CONEN, Oatley, New South Wales (AU); Aideen OSBORNE, Dolans Bay, New South Wales (AU); Gillian BURNS, Arcadia, New South Wales (AU); Ian LANCASTER, Binda, New South Wales (AU)

(21) Appl. No.: 17/291,734

(22) PCT Filed: Nov. 6, 2019
(86) PCT No.: PCT/AU2019/051220

§ 371 Date: May 6, 2021

(30) Foreign Application Priority Data
Nov. 6, 2018 (AU) 2018260834

(51) Int. Cl. A01K 15/02; B68C 1/02

(52) U.S. Cl. CPC A01K 15/02; B68C 1/02

(57) ABSTRACT

A conditioning device for use with an animal to improve the animal's physical well-being and develop physical strength, the device comprising a saddle arrangement for positioning on the back of said animal and a girth assembly for securing the saddle arrangement on the animal, and a compartment assembly located on top of the seat portion of the saddle, wherein the compartment assembly includes an inner space adapted to receive and fixedly hold therein at least one removable weight assembly.

### FIELD OF THE INVENTION

The invention relates to a conditioning device such as a saddle arrangement for use with animals, preferably those of the equine species to improve their physical condition and well-being. Methods of using the device are also disclosed.

### BACKGROUND ART

The following discussion of the background art is intended to facilitate an understanding of the present invention only. It should be appreciated that the discussion is not an acknowledgement or admission that any of the information referred to was part of the common general knowledge.

Animals of varying species have been subject to domestication by humans, and likely as a co-evolutionary process for millennia. Based on historical evolutionary analysis it is believed that there are three pathways that domestication took. They included domestication of what might be called the relationship animals, that is cats and dogs, with dogs being the first domesticated species in the late Pleistocene era. The second pathway was associated with prey animals such as sheep, goats, cattle and the third pathway working (or draft) animals such as the horse and donkey.

However, with man's continued intervention in the evolution process it might be considered that we have evolved some animals to the extent that they are suited for such very specialised purposes, such as sporting prowess and strength (e.g. horses for dressage, sport and working horses) or as desirable pets (e.g. dogs).

A particular example is the horse. It has a well known domestication history dating back to at least 2500 BCE, and has been used by humans extensively. It has been used as a food animal, a working animal and as an animal of sport. In our times, the horse is still all of these things in different areas of the world.

One method of developing a successful riding horse is to develop its ability to stabilize its back in order to support a rider. The horse's back must “stiffen” but must also be strong enough to flex and bend. This means that the horse must be very strong in its core muscles—the epaxial muscles as well as the abdominal muscles. An example of a well trained horse are those used in high level dressage.

Dressage is the French word for training and has been adopted as the name for a highly skilled riding form, used both in leisure activities as well as competition. The Federation Equestre International (FEI), which is the international governing body of equestrian sport, considers dressage to be “the highest expression of horse training”.

The essential purpose of dressage is to develop the horse's natural athletic ability through a progression of training exercises and experiences to establish the horse's future as a useful riding horse. This sort of training, however, is expensive and should be undertaken by experienced elite trainers, who are difficult to find. It usually requires an elite trainer to work with the horse overs several years to establish it even as a useful low level horse.

A horse being trained by an elite rider/trainer will have its core muscles including the epaxial muscles developed carefully and progressively over time. Unfortunately, most horses are not trained by elite riders. In fact, many people purchase horses who have been incorrectly or poorly trained and have weak core stabilizing muscles. Very few of these horses will ever develop strong core muscles unless training is undertaken at a high level. Even then, some larger horses, such as warmbloods, will never be trained to use their backs properly.

As such there are welfare considerations for horses that are weak through their back and spine. It is believed that there are a large number of horses that, while being ridden on a regular basis, are in fact being ridden incorrectly by inexperienced and unbalanced riders and therefore may be predisposed to developing spinal pathology. This results in acute and chronic pain which is often unrecognised. There is also a lot of misunderstanding about what the pain means and how to resolve it. In a large number of cases, strengthening the horse's core muscles strengthens the horse's back and resolves the ongoing pain.

Without a strong core, the horse becomes susceptible to damage that results from instability in the bony spinal column. The intervertebral joints are stressed, as are the ligaments of the back. Several conditions are now recognized in horses that can develop from instability in the back. These include intervertebral joint arthritis, overriding dorsal spinous processes and ligament desmitis, amongst others. Once any one of these conditions develops, there is a concurrent reduction in size of the multifidus muscle, one of the core stabilizing muscles. As the weakness and damage in the horse's back continues, pain develops, causing the horse to develop an incorrect way of going. This often accentuates the weakness in his back, resulting in further pain. Many horses eventually develop misbehaviours such as bucking, kicking or napping, all of which reduce his value as a riding horse. As the condition progresses and worsens, he loses all value, becoming either neglected in a paddock or sent to slaughter.

While there have been improvements in saddle design and the like, unfortunately the best way to improve a horse's core strength is to engage an elite rider/trainer to work with the horse and apply known training/riding techniques. This is time consuming and expensive and the techniques to be used are typically beyond the capability of most horse owners.

Several other methods have recently been proposed to develop a horses' core strength including dynamic stabilization exercises, Theraplate® therapy, and FES (Functional Electrical Stimulation) therapy.

Dynamic stabilization (mobilization) exercises typically involve the use of a food stimulus, such as a carrot, being offered to a horse and the horse is made to stretch off its centre of gravity to reach the food source without moving its legs. This causes the horse to engage its core muscles to hold its balance. Given the interactability required with a trainer, this process, whilst showing some positive results, is a slow and tedious process and requires considerable time to achieve an outcome.

Theraplate® technology is one name for the Vortex Wave Circulation Stimulation Technology. This machine causes a dynamic movement of the animal by the application of a rotational vortex like movement (and vibration) of a platform on which the animal, such as a horse stands. It is believed to cause increased circulation of blood, increased bone density and muscle mass and results in reduced swelling and inflammation. It may also result in increased proprioceptive neuromuscular function and enhanced muscular function. The exact mechanisms that lead to these results have not been elucidated.

Functional Electrical Stimulation (FES) uses a pulsating electrical current to direct the movement of muscles, tendons and ligaments through the replication of the natural motor nerve impulses. FES has been shown to be an extremely effective type of electrical stimulation for the rehabilitation of injuries, as well as for reducing the stress and strain of training. It is postulated that FES, for horses, feels like a deep muscle massage but brought about by electrical stimulation of muscles.

Unfortunately, both the Theraplate® and FES therapeutic devices are expensive and generally not available to the general horse owner and for practical purposes are considered more as specialist rehabilitation machines.

As mentioned above other approaches have been developed to assist in core development, such as specific horse riding/training techniques, but these methods like those that have been developed in the dressage arena, can be very difficult to learn for the average park rider.

Whilst the above discussion has concentrated on the equine species other domesticated animals such as donkeys and mules, who have a similar physical shape and who also suffer similar back conditions, and some species of dogs, namely the larger breeds (German Shepherds, Labradors, Wolf Hounds, Great Danes and the like), that can be companion animals but also used for sport and in certain work environments, also suffer back problems and are equally in need of improved methods of treatment of back conditions through the improvement of their core strength.

It is therefore an aim of the present invention to provide a device that is simple to use and is effective compared to other devices of the prior art and provide methods of use of the device to overcome or at least ameliorate the disadvantages of the prior art and improve the physical well-being and attributes of an animal.

### DISCLOSURE OF THE INVENTION

In a first aspect of the invention there is provided a conditioning device for use with an animal to improve the animal's physical well-being and develop physical strength the device comprising a saddle arrangement for positioning on the back of said animal and a girth assembly for securing the saddle arrangement on the animal;
wherein the saddle arrangement includes:
   (i) a weight-bearing seat portion;
   (ii) two side panels affixed to the seat portion wherein the panels extend downwardly from the seat portion base such that the panels lie substantially along the sides of the animal;
      having at least one girth connecting arrangement attached to the seat portion, and a compartment assembly located on top of the seat portion, wherein the compartment assembly includes an inner space adapted to receive and releasably hold therein at least one removable weight;
and wherein the girth assembly includes:
   (iii) at least one strap adapted to engage with the girth connecting arrangement and adapted to secure the entire arrangement on the animal.

In a second aspect of the invention there is provided a conditioning device for use with an animal to improve the animal's physical well-being and develop physical strength the device comprising a saddle arrangement for positioning on the back of said animal and a girth assembly for securing the saddle arrangement on the animal;
wherein the saddle arrangement includes:
   (i) a weight-bearing seat portion, said seat portion having a front end (pommel) and a rear end (cantle) and wherein said portion adapted to be positioned on the back of said animal;
   (ii) two side panels affixed to the weight-bearing seat portion wherein the panels extend downwardly from the seat portion such that the panels lie substantially along the sides of the animal;
   (iii) at least one girth connecting arrangement; and
   (iv) a compartment assembly located on top of the weight-bearing seat portion of the saddle, wherein the compartment assembly includes an inner space adapted to receive and releasably hold therein at least one removable weight assembly;
and wherein the girth assembly includes:
   (v) at least one strap adapted to engage with the girth connecting arrangement and wherein the at least one strap extends between the two side panels and loops around the underside of the animals body; and
at least one securing arrangement located at a distal end of the strap and which is adapted to engage with the at least one girth connecting arrangement.

Preferably the saddle arrangement sits on the animal's back in a manner similar to a normal equine (horse) saddle. The use of the term seat portion is to assist the reader as to the relative orientation of where the seat portion is located on the saddle arrangement although no seat per se is provided thus distinguishing the present invention from a traditional saddle.

Preferably the side panels (skirts) co-operate to define a raised central ridge that itself defines a central channel extending along the horizontal length of the saddle arrangement and defines two opposing side panels of the saddle arrangement. Preferably the side panels can be formed in one piece or provided as two separate panels that are joined at the raised central ridge. Preferably the configuration of the side panels defining a raised central channel prevents, limits and/or reduces pressure on the animal's spine.

Preferably located on the underside of the side panels and near the raised central ridge/channel are two elongate shaped cushions that preferably run the horizontal length of the saddle arrangement. The cushions being designed to provide protection between the animal's sides at or near the spine and the saddle arrangement. Preferably the cushions are filled with a suitably resilient material, such as but not limited to flock, wool, cotton, other synthetic fibre materials or combinations thereof, and thus providing a cushioning effect.

Preferably the compartment assembly of the first and second aspects of the invention comprises at least one support base structure fixedly attached to the weight bearing seat portion and which generally sits in a horizontal plane relative to the ground. Preferably the at least one support base structure is further stabilised by at least two separate auxiliary bases that are fixedly attached to the respective near and far side panels of the weight bearing seat portion and preferably extend along the horizontal length of the seat portion and on either side of the central ridge. Preferably the support base further comprises at least one base section having an upwardly extending walled perimeter that defines an inner space thereby forming a compartment, and a lid for enclosing the inner space. In an alternative embodiment the compartment is a separate compartment structure having an inner space, wherein the separate compartment structure is adapted to attach directly to the support base structure.

Preferably the auxiliary bases are in the form of trapezoidal prisms or triangular prisms. Preferably the attaching face of the auxiliary bases is complementary in shape to the shape of surface of the side panels to which they attach. Preferably the auxiliary bases are fixedly attached to the side panels and more preferably at or near the upper portion of the side panels. In another preferred form the two support bases are only partially fixed to the upper sections of the side panels this allowing limited movement of the compartment assembly. Preferably the compartment further includes a base plate that is adapted to fit on the upper surface of the at least one base support thereby defining a floor of the inner space.

Preferably the lid is integral with the perimeter wall and includes a securing arrangement to secure the lid to the perimeter wall. Preferably the securing arrangement is selected from the group of securing means consisting of zippers, a hook and loop attachment means and belt and buckle arrangement or though other alternatives are also possible. Preferably the securing arrangement is a zipper where the lid has one set of teeth and the perimeter wall the second complementary set of teeth for engagement with the first set of teeth. Preferably the lid is hinged along one side of the perimeter wall. Preferably the lid further comprises a protective flap that extends outwardly around the perimeter of the lid and is adapted to cover and protect the securing arrangement. Preferably the flap is adapted to be secured to the outer upper surface of the support base perimeter wall. Preferably the inner surface of the flap cooperates with a complementary surface located on the outer surface of the perimeter wall such as by a hook and loop arrangement (e.g. Velcro®). In a further alternative embodiment the flap is secured to the perimeter using simple snap locks.

In an alternative embodiment the compartment assembly comprises a support base structure including a base, a perimeter wall and a lid, wherein the base, perimeter wall and lid are integral with one another and wherein along one side of the perimeter wall there is provided a securable opening, the opening being adapted to allow the insertion of the at least one weight assembly into the inner space of the compartment.

Preferably when the at least one support base(s) is (are) partially fixed to the weight bearing portion the auxiliary bases further comprise additional securing means to secure the at least one support base(s) to the upper portions of the side panels. Preferably the additional securing means is selected from support webs fixedly attached to the side walls of the support base and extending to the upper portion of the side panels where they are fixedly attached, at least one releasable belt and buckle strap on each auxiliary base and side panel, at least one releasable snap lock engagement means on each side, at least one hook and loop attachment means on each side. Preferably when the securing means are support webs they extend along the two long edges of the support base and wherein one long edge attaches to the edge of the auxiliary support base and the other longer edge attaches to the side panel. Preferably the support flaps are resiliently elastic.

Preferably the saddle is selected from a saddle that includes a tree frame or can be a treeless saddle.

In a third aspect of the invention there is provided a conditioning device for use with an animal to improve the animal's physical well-being and develop physical strength the device comprising a saddle arrangement for positioning on the back of said animal and a girth assembly for securing the saddle arrangement on the animal, wherein the saddle arrangement comprises:
(i) a saddle tree like assembly comprising a front end (pommel) and a rear end (cantle) and two side arms that join the front and rear ends and wherein the front and rear ends and side arms define a centre hollow lying between said pommel, cantle and side arms, and wherein the tree has an upper surface and a lower surface and wherein the shape of the tree acts to define the seat portion of the saddle arrangement and substantially conforms to the shape of the animal's back on which the saddle arrangement is to be placed;
and wherein on the under surface of the tree there is attached a cushion assembly wherein the cushion assembly in cooperation with the tree defines a hollow space that runs the length the of the tree when the saddle arrangement is in use on the animal and to lift the device off the animal's spine;
(ii) side panels that are fixedly attached to the near and far sides of the tree frame which overlap with the cushion assembly;
(iii) a cover assembly that sits substantially atop the tree assembly and extends over the tree assembly to define a substantially flat surface;
and wherein the tree assembly and cover assembly define a substantially flat upper portion;
(iv) a compartment assembly located on top of the upper portion of the saddle arrangement, wherein the compartment assembly includes an inner space adapted to receive and releasably hold therein at least one removable weight;
and wherein the girth assembly includes:
(v) at least one strap adapted to engage with a girth connecting arrangement and wherein the at least one strap extends between the two side panels and loops around the underside of the animals body; and at least one securing arrangement located at a distal end of the strap and which is adapted to engage with the at least one girth connecting arrangement.

Preferably the saddle tree like assembly (the tree) comprises a frame having a raised pommel end and a substantially flattened cantle end and a centre hollow lying between said pommel and cantle ends and wherein the hollow is defined by two curved arms that respectively extend along the near and far sides of the tree from the pommel and cantle ends and joining the pommel and cantle ends. The centre hollow extends substantially from the pommel end to the cantle end. Preferably the cantle end includes a flattened portion that lies substantially in the same plane as the curved arms and extends upwardly from the curved sides. The pommel also slopes upwardly from the curved arms which attach to respective near and far side arms of the pommel to define an apex point (top) at the centre joint of the pommel. The upwardly sloping curved arms in co-operation with the pommel arms define a space (a gullet) lying between the two curved sides substantially as found in an equine saddle tree. Further the pommel arms also extend downwardly and outwardly from the apex of the pommel, and past the junction of the where the curved arms attach, preferably in a curved fashion, and defining a fork substantially in the form of an inverted U. The tree frame includes an upper surface and a lower surface.

Preferably on the under surface (side) of the tree there is attached a cushioned underlay, wherein said underlay is fixedly attached to the under surface of the tree, although in other embodiments the underlay maybe detachable. The underlay is attached substantially along the entire perimeter surface of the underside of the tree including under the pommel and cantle ends such that substantially the entire under surface is covered. The underlay comprises an upper surface panel and an under surface panel attached to each other along a seam that extends along the entire perimeter of the two surfaces and defining a space between the two surfaces and wherein the space between the two surfaces includes a hollow which is packed with a suitably resilient material, such as but not limited to flock, wool, cotton, other synthetic fibre materials or combinations thereof, thus providing a cushioning effect. The under surface can be substantially flat or can include a raised pattern such as dimples ridges, hexagonal dimples thus providing further resilience. Preferably the underlay further comprises two raised cushions that are attached to the under surface of the underlay and substantially at or adjacent to the side arms of the tree and wherein the cushions extend along the horizontal length of the underlay and substantially along the entire length of the tree, such that the tree and underlay cooperate to define a channel that defines a hollow space between the animal's spine and the under surface of the tree/underlay. As with the underlay the raised cushions are packed with a suitably resilient material, such as but not limited to flock, wool, cotton, other synthetic fibre materials or combinations thereof. The cushions are raised up in relation to the surface of the generally flat surface of the underlay. The cushions can include at one or both ends access means in order that more or less of the filling material can be inserted or removed thus allowing the cushion thickness to be adapted to individual animals. The access means is selected from the group of access means selected from simple releasable seams, zippers, hook and eye (Velcro) means, press studs or the like.

Preferably the tree frame is made of a material selected from the group of materials consisting of wood, or plastic, preferably thermo-moldable plastics, fibreglass and carbon fibre products.

Preferably the hollow of the tree is covered on its upper surface by at least one cover layer, preferably a multi-layered cover, wherein the cover has a substantially flat upper surface. The layers maybe made of leather, plastics, plastic composites, or themo-moldable plastics, synthetics or a combination thereof. In an alternative embodiment the layer assembly is substituted with a molded insert substantially in the shape of the hollow and wherein the insert has a substantially flat upper surface. The insert is preferably made of plastic composites or more preferably a thermos-moldable plastic.

Preferably the side panels are fixedly attached to the near and far sides of the tree running along the perimeter edge thereof, and preferably extending up to the apex of the pommel and to the end of the cantle. Preferably the side panels are made of leather or other resiliently flexible plastic or synthetic material.

Optionally there is further provided an overlay that attaches to and sits atop the tree and extends downwardly on both sides of the tree and preferably along the length of the tree's near and far sides. The overlay may be detachable from the upper surface of the tree.

Preferably the compartment assembly of the third aspect of the invention comprises an outer shell having an inner space designed to receive and secure in place at least one weighted assembly. Preferably the inner space further comprises multiple sub-compartments designed to securely receive and maintain in position multiple weighted assemblies preferably two, more preferably three, still more preferably four sub-compartments. The sub-compartments may be evenly spaced within the compartment to allow the even distribution of the weights(s) or their spatial positioning in the compartment may be randomly selected depending on the type of weight to be used and its physical mass, and wherein the compartment sits atop the substantially flat upper surface of the tree assembly. Preferably the compartment assembly includes an access port for receiving the at least one weighted assembly. Preferably the access port is in the form of a securable lid or more preferably a securable side access port, and preferably located on the near side. Preferably the securable lid or flap is integral with the main body of the compartment. In a particularly preferred embodiment the flap is hinged along the bottom edge of the long side of the compartment and on the near side (that is left hand side of a horse). Preferably the securable lid or flap comprises a securing means to secure the lid or flap to the main body of the compartment. Preferably the securing means is selected from the group consisting of zippers, hook and loop (Velcro) means, eye studs and hook and eyes. In a particularly preferred embodiment the side flap further comprises at least one tab at each end of the flap for securing the flap the side wall of the compartment. Preferably the securing means used on the tabs and compartment is selected from the group consisting of zippers, hook and loop (Velcro) means, eye studs and hook and eyes. Preferably the securing arrangement is a zipper where the flap has one set of teeth and the compartment to which it attaches a second complementary set of teeth for engagement with the first set of teeth of the flap.

Preferably the shape of the compartment assembly is selected from squares, rectangles, circular or semi-circular shapes, although alternative shapes are not excluded.

Preferably the inner space of the compartment is adapted to securely receive and maintain in position the weight assemblies. Preferably the inner space includes a plurality of sub-compartments for the weight assembies, preferably a plurality of weighted assemblies such as two, more preferably three, still more preferably four sub-compartments. The sub-compartments may be equally spaced within the compartment to evenly distribute the weights(s) or their spatial positioning in the compartment may be randomly selected depending on the type of weight to be used and its physical mass. Preferably the weight assembly is sized and shaped to fit within the compartment inner space and/or the sub-compartments More preferably the weight assembly is sized and weighted to be compatible with the animal on which the device is to be used. Each weight assembly is securely fixed within the inner space of the compartment or sub-compartments.

Preferably the at least one weight assembly comprises a flexible hollow body having an outer casing which defines a cavity within the hollow body, the cavity including at least one inner chamber adapted to receive a weight. Preferably there are a plurality of inner chambers, such as two, more preferably three, even more preferably four and still more preferably five inner chambers. In an alternative embodiment the weights can be solid weights that are also adapted to be secured in the inner compartment or sub-compartments.

Preferably the inner chambers are each separately adapted to receive and fixedly hold within the respective chamber at least one removable weight.

Preferably the at least one weight assembly includes a releasable plug or opening allowing for the insertion or egress of the weight. Preferably the weight is selected from the group consisting of fluids, flowable gels and mobile solid weights, and solid weights.

Preferably the weight within the weight assembly is moveably dynamic and more preferably is variably moveable. Preferably the weight within the weight assembly can move along a horizontal plane substantially defined by the spinal orientation of the animal, that is from the head to the flank. In another preferred form the moveable weight can also move in a substantially side to side manner, such as from the near side to the far side of the animal. In yet a further preferred manner the moveable weight can move in both the horizontal plane substantially defined by the spinal orientation of the animal, that is from the head to the flank and in a substantially side to side manner, that is near to far or far to near side of the animal. That is the weight will move in a random fashion based on the animal's movement.

Preferably the weight is within the range selected from 500 grams to 20 kilograms, 500 grams to 19 kilos, 500 grams to 18 kilos, 500 grams to 17 kilos, 500 grams to 16 kilos, 500 to 15 kilos, 500 grams to 14 kilos, 500 grams to 13 kilos, 500 grams to 12 kilos, 500 grams to 11 kilos, 500 grams to 10 kilos, 500 grams to 9 kilos, 500 grams to 8 kilos, 500 grams to 7 kilos, 500 grams to 6 kilos, 500 grams to 5 kilos, 500 grams to 4 kilos, 500 grams to 3 kilos, 500 grams to 2 kilos and 500 grams to 1 kilo. The selected weight being dependent on the size, age and experience of the horse.

Preferably in use the weight assemblies may be used as solid weights, flexible weights or a combination of the two within the compartment.

Preferably the at least one girth engagement arrangement comprises at least one strap preferably two, even more preferably three straps fixedly attached to the saddle, wherein each strap includes at its distal end a receiving portion to releasably engage with and secure the girth assembly. Preferably there are two girth engagement arrangements one each located on each of the side panels of the saddle. Preferably the at least one strap, preferably two, even more preferably three straps are fixedly attached to the saddle at the mid-point of the saddle side panel, more preferably they are fixedly attached near the top of the side panels. Preferably the distal receiving portion is selected from a belt having receiving holes, a releasable snap lock arrangement, a separable fastener arrangement, a tie, a hook and loop arrangement and any combination thereof.

Preferably the girth assembly comprises one, two or three straps and wherein each strap includes at their respective distal ends at least one securing arrangement for releasable connection with the at least one girth engagement arrangement of the saddle. The releasable connection is selected from the group consisting of a belt and buckle, a releasable snap lock arrangement, a separable fastener arrangement, a tie, a hook and loop arrangement and any combination thereof.

Preferably the girth assembly further comprises a supporting gusset fixedly attached to the at least one strap.

Preferably the device further comprises a plurality of guide rings suitable to accommodate at least one training line/rein and more preferably the guide rings are shaped such as O or D rings. Preferably the guide rings are spaced about the seat, surcingle or girth straps.

Preferably there is at least one guide ring located at the rear/cantle of the saddle. Preferably there are several on the rear aspect of the device, and preferably located on the side panels.

In a further aspect of the invention the device comprises a surcingle assembly, wherein the surcingle includes:

(i) an upper portion having at least one hollow compartment located thereon and wherein the at least one compartment is adapted to receive and fixedly hold therein at least one removable weight; and

(ii) a girth assembly comprising at least one strap adapted to encircle the girth of the animal comprising a securing means to secure the strap around the girth of the animal

Preferably the surcingle assembly includes on its underside cushioning panels adapted to engage with the animal's back and preferably along the epaxial muscles either side of the spine.

Preferably the securing means is a belt and buckle arrangement.

Preferably the surcingle further comprises at least one guide ring, preferably as an O ring, located on the surcingle but not on the surcingle girth strap.

Preferably movement of the animal causes the weight within the weight assembly to move thereby causing the animal to adjust its movement to maintain activation stability.

Preferably the saddle arrangement of the first, second and third aspects of the invention or surcingle/harness assembly including the weighted assembly is positioned on the back of the animal between the withers and loin.

Preferably the saddle arrangement for equine species is positioned about thoracic vertebrae T6 or T8 extending to between T16 to T18. The exact positioning being dependent on the species and size of the animal. Preferably the species is the equine species and more preferably the domesticated horse.

Preferably the surcingle assembly is sized and shaped to fit the animal, and more preferably an equine species, such that the surcingle is located preferably at or near the thoracic vertebrae T 7 to T 10.

Preferably the saddle arrangement or surcingle assembly is positioned over the epaxial musculature of the animal.

Preferably the saddle arrangement is further adapted to receive and secure a breastplate and/or crupper.

In yet a further aspect of the invention there is provided a method for improving the physical wellbeing of an animal the method comprising the steps of using the device of the invention with said animal and engaging said animal in an exercise routine.

Preferably the exercise routine for an equine animal is selected from the group of exercises consisting of gait exercises, training exercises and advanced training exercises. Preferably the gait exercises are selected from walking, trotting and cantering, the training exercises being selected from lunging, longlining, driving and riding, and advanced exercises are selected from the group of exercises such as but not limited to using ground poles, varied terrain and cavaletti.

Preferably the exercise routine is carried out for a period of time selected from the range of from 1 minute, to 2 minutes, to 3 minutes, to 4 minutes, to 5 minutes, to 6 minutes, to 7 minutes, to 8 minutes, to 9 minutes, to 10 minutes, to 11 minutes, to 12 minutes, to 13 minutes, to 14 minutes, to 15 minutes, to 20 minutes, to 25 minutes, to 30 minutes, to 35 minutes, to 40 minutes and to 45 minutes. For the avoidance of doubt the time interval can be between any of these time intervals. Preferably the animal is subject to the exercise routine for between 5 to 15 minutes, still more preferably 10 to 30 minutes.

Preferably the animal is selected from the group consisting of quadrupeds including but not limited to equine species, canine species, caprine species, and bovine species.

### BRIEF DESCRIPTION OF THE DRAWINGS

Notwithstanding any other forms which may fall within the scope of the present invention, a preferred embodiment of the invention will now be described, by way of example only, with reference to the following drawings.

FIG. 1 depicts a schematic diagram of the musculature of a horse.

FIG. 2 depicts a side view of an aspect of the invention positioned on a horse.

FIG. 3 depicts a front top left (near) side perspective view of an aspect of the invention.

FIG. 4 depicts a bottom rear (near) side perspective view of an aspect of the invention.

FIG. 5 depicts a rear right (far) hand perspective view of an aspect of the invention.

FIG. 6 depicts an exploded view of a conditioning device of an aspect of the invention.

FIG. 7A depicts a top perspective view of the weight holding compartment and weight assembly unassembled.

FIG. 7B depicts a bottom perspective view of the assembled weight holding compartment and weight assembly.

FIG. 8 depicts a front perspective view of the weight assembly.

FIG. 9 depicts an exploded view of a conditioning device of an aspect of the invention.

FIG. 10 depicts a front near side perspective view of an aspect of the invention.

FIG. 11 depicts a bottom near hand side view of a conditioning device of an aspect of the invention.

FIG. 12 depicts a front perspective view of an alternative weight assembly of the invention.

### BEST MODE(S) FOR CARRYING OUT THE INVENTION

It should be noted in the following description that like or the same reference numerals in different embodiments denote the same or similar features.

As used herein and throughout the specification, unless the context requires otherwise, the word “comprise” or variations such as “comprises” or “comprising”, will be understood to imply the inclusion of a stated integer or group of integers but not the exclusion of any other integer or group of integers.

Any one of the terms “including” or “includes” as used herein is also an open term that also means including at least the elements/features that follow the term, but not excluding others. Thus, including is synonymous with and means comprising.

As used herein the singular forms of ‘a’, ‘and’ and ‘the’ include plural referents unless the context clearly dictates otherwise.

Unless otherwise defined, all technical and scientific terms used herein have the same meaning as commonly understood by one of ordinary skill in the art to which this invention belongs.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

The invention will now be described with reference to the Figures and in particular its use and application with horses.

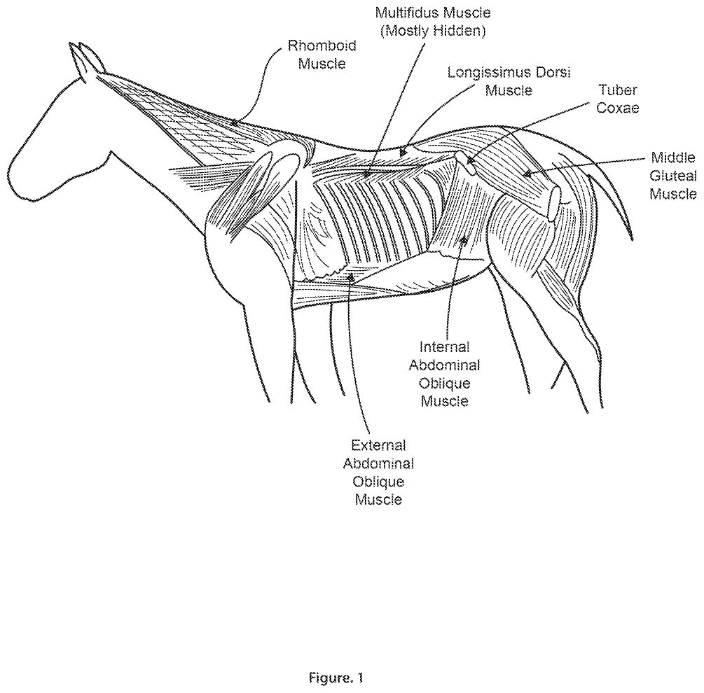

FIG. 1 depicts the musculoskeletal structure of the back of the common horse, Equus callabus, which is one of the animal species for which the device has been developed.

Without wishing to be bound by any particular scientific theory it is believed that the device and method of the invention will facilitate the development of the thoracolumbar muscular strength of an animal and in particular a horse through its action on the following musculoskeletal structures.

The longissimus dorsi muscle is a complex of muscles which originate from either the front and underside of the pelvis or the dorsal spinous processes of the thoracic, lumbar and first three sacral vertebrae. These segments insert in various sites including the transverse processes of the thoracic and lumbar vertebrae as well as the last four cervical vertebrae. They may also insert on the lateral aspect of the ribs and the lumbar articular processes. Lying underneath the longissimus dorsi is another segmented muscle, the multifidus muscle. The segments of this muscle attach to the vertebral spinous processes, each one bridging 2-3 vertebral segments.

The longissimus dorsi and multifidus muscles together are involved in locomotion as well as stability of the back. These muscles must be well developed if they are to withstand the weight of a rider and at the same time protect and stabilize the underlying skeletal structures. If weak or undeveloped, the horse is predisposed to articular facet injury, dorsal spinous process injury or other similar pathological processes.

The muscles of the abdomen, including the transverse abdominus, rectus abdominus and the two oblique muscles are also important in the stability and strength of the horse's core and the strength and stabilization of the back.

Despite popular misconceptions horses are not innately adapted to be ridden. They evolved to be able to accelerate to a high speed over medium distances to escape predation. For this reason, they do not naturally adopt the best form for carrying a rider.

Horses are now used mainly as a sport animal in the Western world, and most disciplines require the horse to be ridden or to pull a cart. While most horses adapt to this requirement readily, they do not innately know how to carry a rider.

The horse must be trained to carry a rider correctly through the development of its core and epaxial muscles, specifically the longissimus dorsi muscles, the multifidus muscles and the abdominal muscles. These muscles are used to “collect” or “engage” the horse. When these muscles are correctly developed, the horse flexes its back, brings its hind legs under the body and thus has a strong and stable back. A horse with well-developed core strength is much less likely to suffer damage to the articular facets of the vertebrae or other pathologic conditions of the spine.

Biomechanical studies have shown that the stability of the spine, epaxial muscles and their innervation are important in strengthening the horse's back to support a weight. The horse must also be taught to engage it's abdominal muscles. This girdle of muscles of the back and abdomen are considered to be a horse's core muscles. It was believed, many years ago, that all a horse needed was to be “broken in” which means trained to take a saddle. Once the horse accepted the saddle and rider, it was considered ready to start working. We now recognize the importance of starting a horse correctly both on the ground and under saddle. For many horses, however, this early training is either very brief or non-existent. Most horses are trained only under saddle and many horses do not get the benefit of correct training and ground work in these important early days. Riders also vary dramatically in size, shape and ability. Most horses, in fact, will be ridden by riders who cannot achieve the levels of training required to keep their horse's back strong. These horses are predisposed to developing spinal pathology and pain because of incorrect riding technique.

Once started under saddle or even before, a horse should be trained and conditioned. This requires significant investment in both time and money if it is to be done correctly by a good trainer. The purpose of the present invention is to provide a horse owner with both a device and method of use thereof to be able to improve their horse's strength and comfort and assist in training the horse more effectively and efficiently. It is believed that the device and method of the invention will be applicable to all standard English riding disciplines, Western riding, as well as carriage driving, vaulting and potentially in training young horses that may be used in the racing arena. The conditioning device of the present invention might be particularly useful in training and conditioning the larger warmbloods and dressage horses.

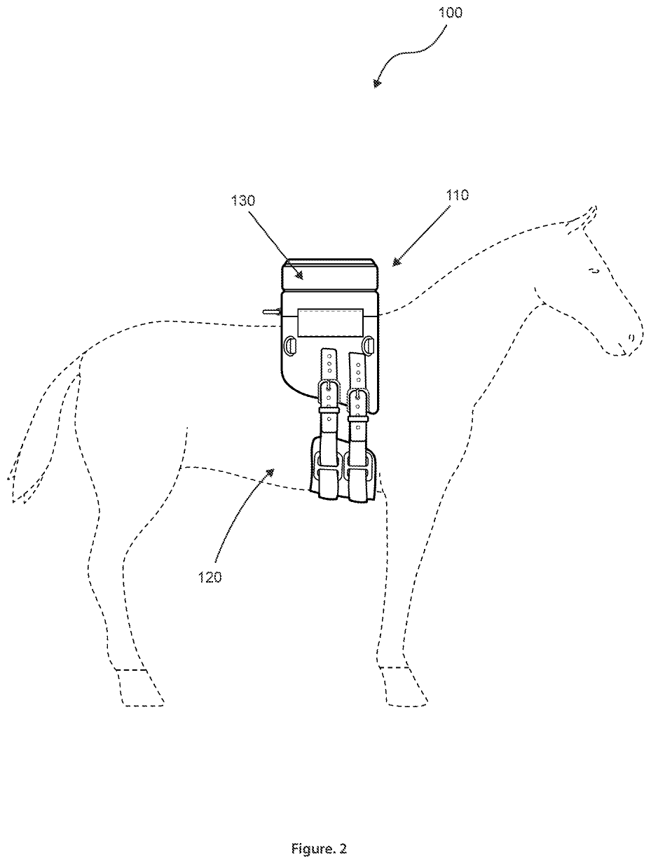

Turning to FIG. 2 there is depicted an embodiment of the invention, including a conditioning device 100 for use in conditioning a horse. The conditioning device 100 comprises a combination saddle arrangement 110 and a girth assembly 120 for securing the conditioning device on the horse. Located on the top portion of the saddle arrangement is a compartment 130 that is hollow and designed to receive a weight assembly (not shown). The compartment 130 is designed to sit generally in a horizontal plane relative to the ground and optionally the horse's thoracic spine. The device 100 is typically positioned so that the saddle sits just behind the wither at approximately the level of thoracic vertebrae T6 to T8 and extends backwards to approximately T16 to T18 vertebrae. The positioning of the saddle arrangement is important and the girth assembly should be positioned just behind the foreleg as shown and preferably located such that the girth assembly is positioned similarly to an English saddle, with the girth lying in the girth groove of the horse's barrel.

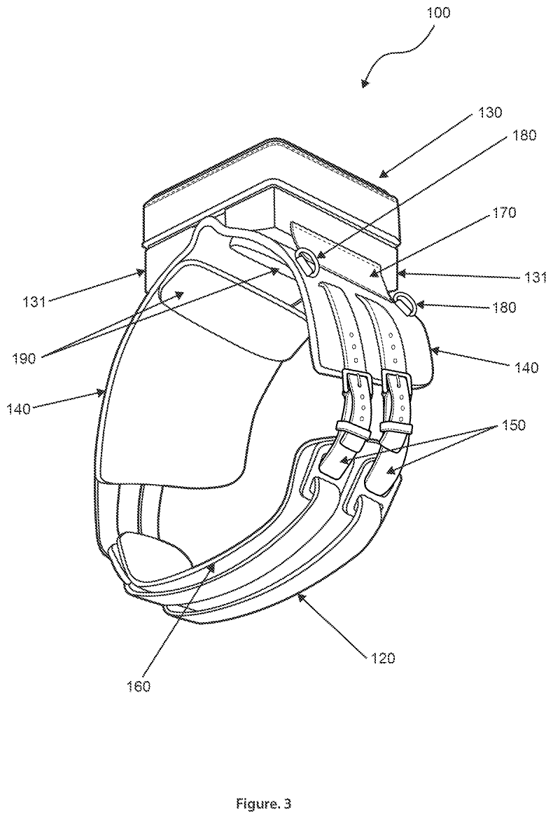

Turning to FIG. 3 there is shown a front side perspective view of the conditioning device 100. The device includes a saddle portion 110 and girth assembly 120 that co-operate with one another to define the invention for use on a horse. The girth assembly can be present in a variety of formats including a single girth strap, or two girth straps 150 as shown in the Figures, or possible three girth straps. In a further embodiment (not shown) it is possible to have a single girth strap having dual belt and buckle attachments at either end of the girth strap (that is two belt and buckle attachments) and which then attach to belts secured to the side panels. The receiving strap/belt sections 151 of the girth connecting arrangement found on the side panels can be of the usual saddle construction such as being leather stitched to a nylon webbing (not shown). In another form the girth straps can be attached to the side panels using a loop arrangement.

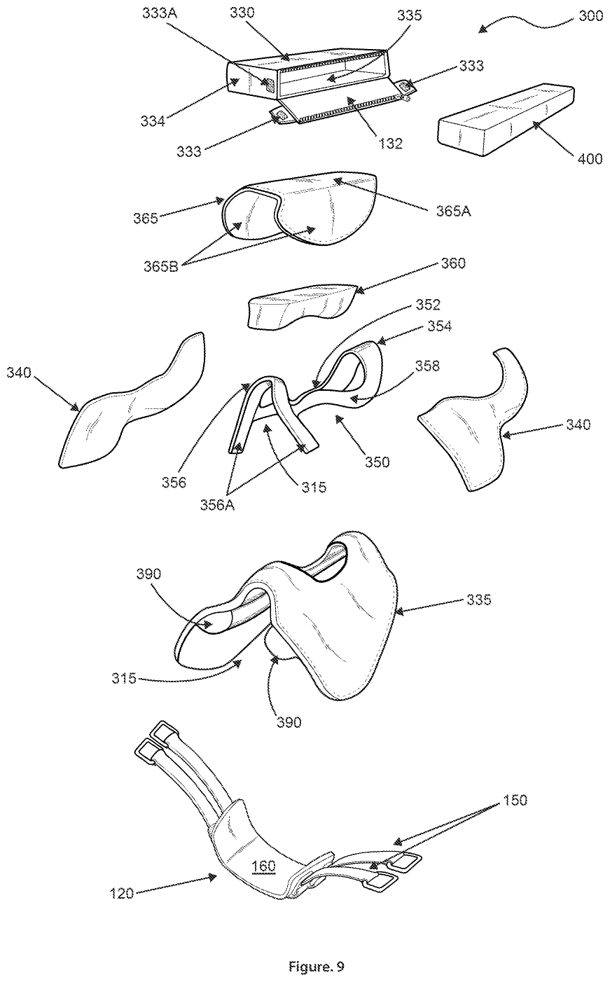

More particularly the saddle portion 110 may include a tree section that acts (not shown in this figure as it lies within the saddle but illustrated in FIG. 9) to provide support and stabilise the device on the animal's back. The inclusion of the tree is discussed in more detailed with reference to FIGS. 9 to 11. A saddle tree is traditionally made of a laminated wood and can include a reinforcing spring located along its length. It may also include a plate riveted to the tree to help form the gullet 115 which is itself a void space formed between the animal's back and the apex ridge 145 of the saddle assembly.

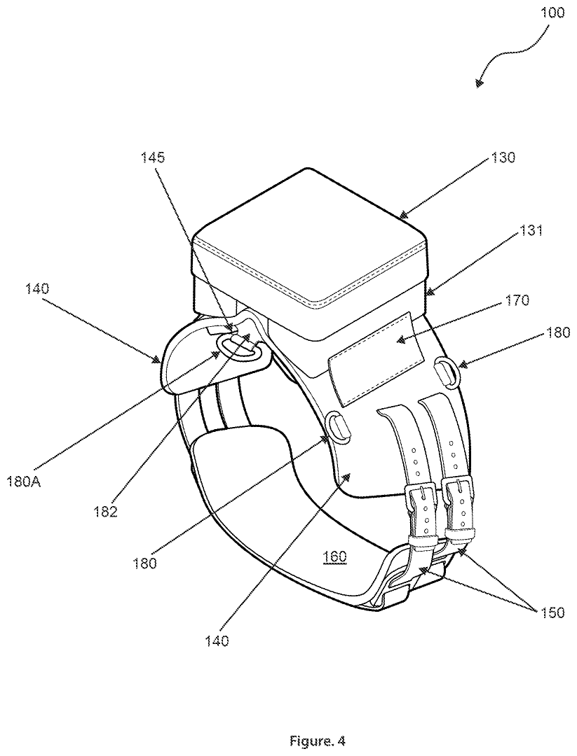

It is envisaged that the conditioning device can also be a treeless saddle like arrangement, and the saddle arrangement can be formed from one piece as shown in FIG. 3. It is also possible that the saddle arrangement in either a tree or treeless form can be resiliently flexible such that it moves easily in conjunction with the horses' dynamic motion. As with saddles in general, the saddle arrangement of the invention also has a gullet 115 which is defined by the two side panels 140, in cooperation with the inner cushioning panels (see FIG. 4), the side panels extending outwardly and downward from the upper apex portion of the saddle 145. In the present formation the side panels 140 are contiguous with one another and the apex 145, although they can be separate and thereby attach separately to the upper portion of the saddle. The gullet 115 is such that it clears the withers of the horse and this is achieved by the shape and formation of the gullet.

Located on the upper portion of the saddle 110 is a compartment 130. The compartment includes an upper section, that is hollow (not shown in FIG. 3) and which is designed to receive a weight, and a support structure comprising two base supports 131. The base supports 131 stabilise the compartment on the upper section of the saddle. The base support structures 131 are located on the upper right and left hand sides of the saddle 110 and engage with the upper portion of the saddle side panels 140, and run along the horizontal length of the saddle.

In an alternative embodiment the compartment 130 and auxiliary base support structures 131 can be integrally formed as one piece that attaches directly to the upper portion of the saddle. In still a further embodiment the auxiliary base support structures 131 can be provided as a single base support, not two separate structures. Yet a further embodiment can include a single base support structure that is integral with the compartment and which can be attached directly to the saddle.

Providing further structural and stabilizing support between the compartment 130 and side panels 140 are support flaps 170 that directly attach to the sides of the auxiliary base supports 131 and side panels 140. These side flaps are resiliently flexible thus allowing for some, but limited, movement of the compartment 130 overall, particularly when the compartment is loaded with weight. The support flaps 170 are preferably stitched onto the side walls of the base supports 131 and also the saddle panels 140.

In alternative embodiments the illustrated elasticized support flaps 170 can be secured using securing options known in the art including belt and buckle arrangements, releasable snap lock arrangements, hook and loop arrangements (Velcro®).

The girth assembly 120 comprises girth straps 150 that extend from one side panel 140 to the opposing side panel 140 and are adapted to securely engage with the girth connecting arrangement receiving straps 151 and are tightened using a simple belt and buckle arrangement. In one embodiment the girth assembly 120 can be completely detachable from the saddle. In a further embodiment (not shown) the girth assembly 120 can be permanently fixed to just one of the side panels 140 either via the saddle the receiving straps 151 having one or a set of belt and buckle attachments or by other means such as stitching. Located at the mid-section of the girth assembly 120 there is provided an optional gusset support 160 that is designed to fit securely on the underbelly of the horse and prevents rubbing of the straps on the underbelly of the horse thus limiting irritation.

FIG. 4 shows the same embodiment as illustrated in FIG. 3 but depicted from the perspective of below the saddle looking upward. In this embodiment the additional feature of inner cushioning panels 190 is shown. These cushioning panels 190 are designed to ensure that the saddle fits properly on the back of the animal, which if necessary can be used in conjunction with a saddle blanket. The cushion panels 190 are stuffed with compatible flocking material that provides a resiliently flexible cushion. The cushioning panels 190 are typically fixedly attached to the inner surface and at the upper inside portion of the side panels and are typically stitched in place, however alternative securing means are envisaged such as using hook and loop attachments. While the cushioning panels 190 are represented as being a flat/planar type format, they can be provided in a variety of shapes, sizes and configurations known in the art of saddlery. Alternative attachment means for the girth straps are also envisioned such as using Velco® strapping. The girth straps 150 extend between the opposing side panels 140 and support the gusset 160 and attach to the girth connecting arrangement receiving straps 151. The gusset 160 can be attached to the girth straps 150 by direct stitching or alternate securing means such as hook and eye connections (e.g. Velcro®) or male/female snap lock connectors. Again, as the device is for conditioning and will not include the weight associated with a rider these alternative securing means could be adopted.

In FIG. 4 the base support structures 131 do not follow the curve of the side panels 140, rather they are shown in an alternative embodiment with the support bases 131 extending outwardly, in the same horizontal plane as the compartment itself. In the embodiment shown the support bases 131 are supported in place by support webbing 170 which attach directly to the sides of the support bases and the side panels and are preferably elasticised and are resiliently flexible. This allows the side panels to fit animals of different sizes and in particular of differing chest dimensions as the structure permits inward and outward movement. Alternative support means to 170 are also envisaged such as simple releasable snap lock arrangements, hook and loop attachments (Velcro®), even belt and buckle arrangements.

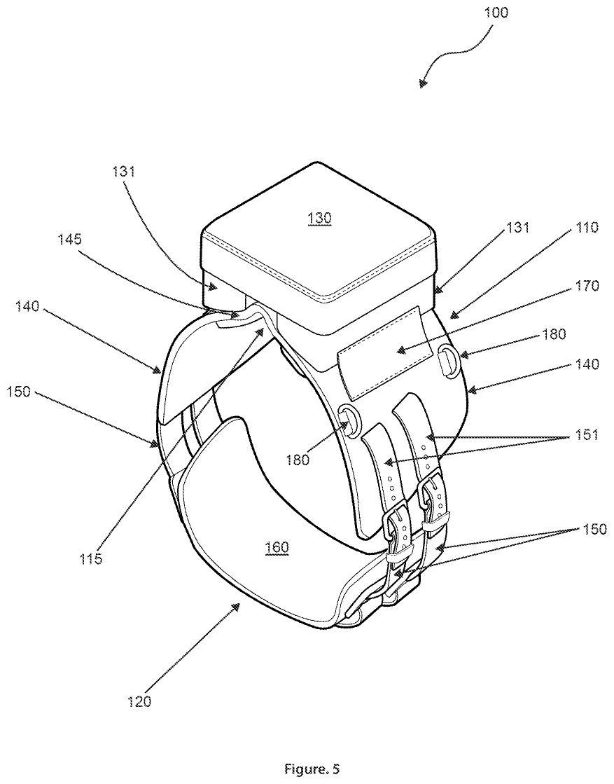

FIG. 5 shows another embodiment of the conditioning device from a rear side perspective view. In this alternate embodiment, which is substantially the same as that shown in FIGS. 3 and 4, the positioning of the D-rings, or any alternative loop structures thereof, are attached directly to the side panels, preferably near the mid-section of the side panels and by standard stitched loop arrangements. The D rings are attached such that they point forward or backwards. A further D-ring 180A is located on the rear end of the apex ridge 145 of the saddle assembly. Preferably the rear D-ring 180A attaches to the apex ridge via a loop arrangement 181 comprising a loop 181A, attached to a tongue portion 182, the loop 181A being adapted to receive and securely hold the longer edge of the D ring, with the tongue portion 182 attaching to the saddle preferably on the inner surface at or near the apex 145. The attachment can be by stitching. This rear D-ring is positioned to receive a crupper (not shown) or other reins arrangement.

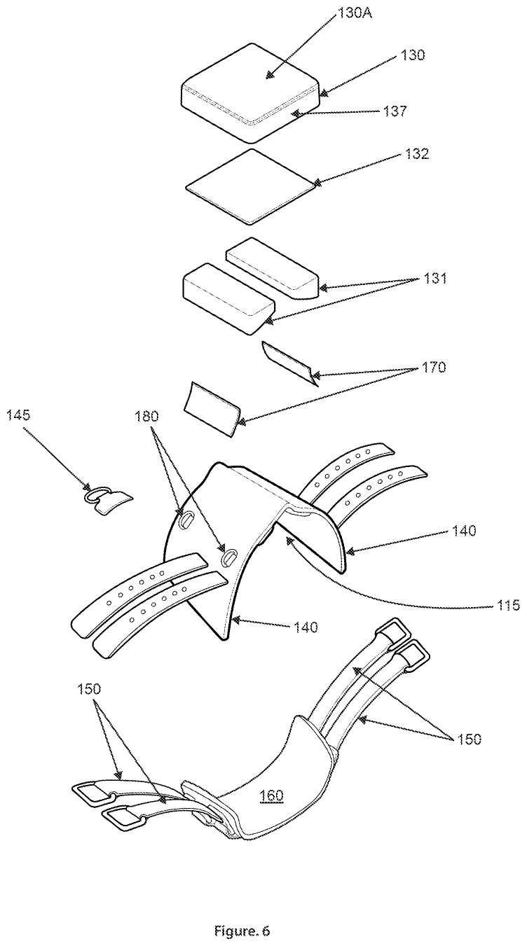

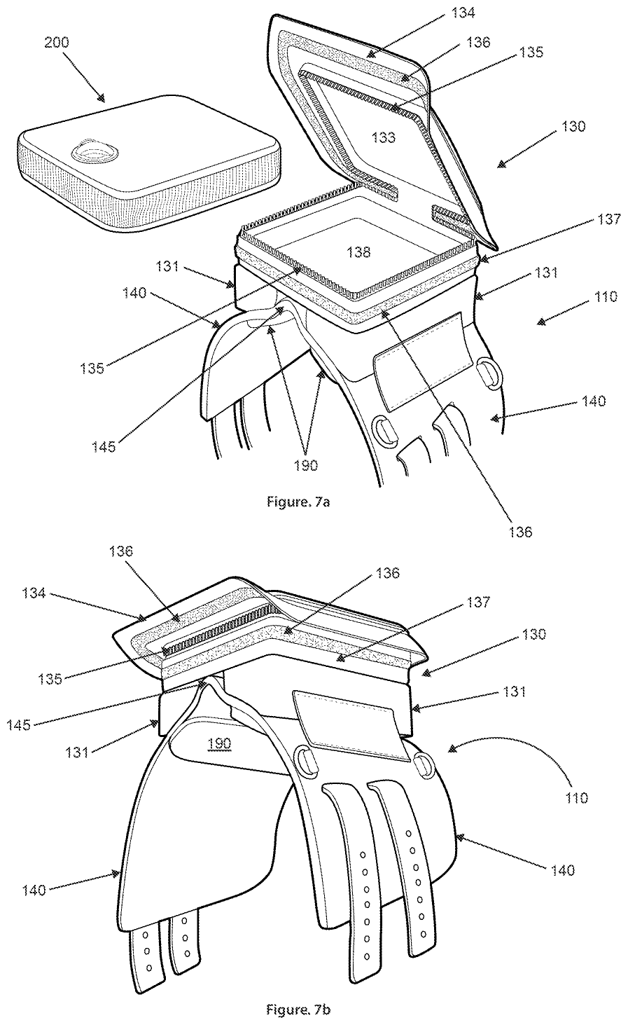

FIG. 6 shows an exploded view of the components of the conditioning device 100. Shown are the compartment 130 for holding the weight and its three main parts namely the support base 132, and two auxiliary support bases 131, that affix to the upper sections of their respective saddle side panels 140. The support base 132 includes an upwardly extending perimeter wall 137 shown here as being part of the upper section of the compartment 130. The lid portion is described in more detail with respect to FIGS. 7A and 7B. The combined compartment 130 and base plate 132 define an inner space (see also FIGS. 7A and 7B). Further shown are the two support flaps 170 that affix to the outer long side walls of the support bases 131 and the saddle side panels 140. The saddle 110 is shown with side panels 140 and the inner cushioning panels 190 cooperating to define gullet 115 (see FIGS. 3 and 6), D-rings 180 are attached to the side panels 140 at a mid-point of the side panels 140 and belt connectors 151 for securing the girth assembly 120. Also shown are the rear D-ring 180A and inner cushions 190. Finally, the girth assembly 120 is shown comprising girth straps 150 with distal end buckles adapted to engage with the girth connecting arrangement belt connectors 151 located on the saddle side panels 140.

Turning to FIGS. 7A and 7B (both front perspective views) show detailed schematics of the compartment assembly 130 and the weight assembly 200 in the open and closed views respectively. As previously described the side panels 140 form an apex 145 of the saddle like arrangement 110, which can also be formed by a tree saddle (not shown). Together with the inner cushioning panels 190 they define a gullet (see FIGS. 3 and 6). Sitting on top of the side panels are two support bases 131, preferably shaped in the form of trapezoidal prisms, although alternative shapes may be used, that extend along the horizontal length of the saddle like arrangement and each support base. The support bases can be either fully affixed to the side panels, or as shown in FIG. 4 partially attached. Atop the two supporting bases 131 lies a base plate 132 (not shown, see FIG. 6) that is fixedly attached to them. Extending upwardly from the support base is a single rectangular wall 137 which defines an internal compartment space 138 and which is proportioned to receive the weight assembly 200 and securely maintain it in position, and without extraneous movement of the weight assembly within the compartment space. On the upper edge of the wall 137 there is a receiving tooth arrangement of a zipper 135 that engages with its counterpart zipper tooth section located on the inner side of the compartment lid 133. Extending outwardly from the compartment lid 133 is a skirt 134 which includes on its inner surface a securing arrangement 136 such as Velcro® tape, and which engages with a counterpart securing arrangement located on the outer edge of the rectangular wall 137. Alternative securing means to maintain the lid in contact with the side wall of the compartment assembly are also envisaged including a plurality of belt and buckle combinations, snap lock combinations or heavy duty loop and hook catches.

In an alternative embodiment the lid 133 is permanently affixed or is integral with the perimeter wall 137 and wherein the perimeter wall includes on any one of its four sides an access port whereby the weight assembly 200 can be inserted into the compartment inner space.

Preferably the compartment inner space also includes a plurality of defined spaces for receiving and securely holding therein the weight assembly(s) such that they do not move within the compartment inner space.

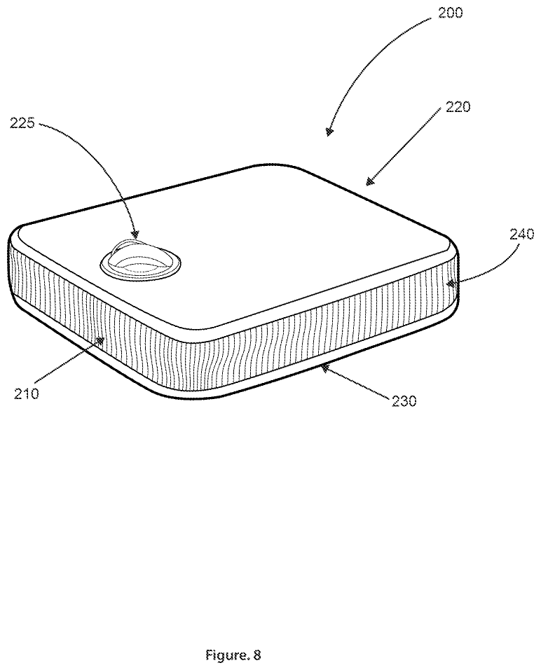

Turning to the weight assembly, FIG. 8 shows a front perspective view of a collapsible weight assembly 200 which is defined by upper and lower surfaces 220 and 230 respectively and a side wall 240 all integral with one another. The three components are stitched together or can be thermally fused along the respective edges to form the weight assembly. There is located on the upper surface a releasable plug 225. In an alternative version the plug can be substituted with a larger access port for use in inserting solid weights. Preferably located within the inner compartment of the weight assembly are polyester fibres (not shown) that provide additional tensile strength when the compartment is expanded. The compartment can be expanded using air and is then suitable for receiving a fluid weight, such as water, a flowable gel or solid via the plug 225. The inner compartment thus allows the flowable weight to move independently of the motion of the animal to which the saddle assembly is secured.

The weight assembly is shown in a generally rectangular shape but it can be provided in other shapes such as square, extended rectangular, even circular or semi-circular, provided it is securely positioned within the compartment 130. In an alternative embodiment the weight assembly can be provided as two separate weight assemblies that together define a single weight and which is received and secured within the compartment 130.

The weight assembly can also be provided in varying sizes which can receive and hold varying weight. This allows the device to be used with animals, preferably horses, of different ages, sizes, temperaments and previous training status.

Preferably the weight assembly can hold anywhere from 50-100 grams of weighted material such as a flowable fluid, to a maximum of 20-25 kilograms, again the weight used being dependent on the age, size, temperament and previous training status of the animal.

Turning to FIG. 9 there is shown an exploded view of a second embodiment of the invention including a conditioning device 300 for use in conditioning a horse. The conditioning device 300 comprises at its centre a tree 350 to which various of the other features are attached as described below.

The tree 350 is includes a frame having a cantle end 354, a pommel end 356, two connecting curved arms 358, and two side arms 356A that extend downwardly from the pommel 356. The curved arms 358 can be separate but joined to the cantle 354 but in the embodiment shown the curved arms 358 extend along a generally horizontal plane from the pommel end 356 to the cantle end 354 and then upwardly to form the cantle 354. In a particularly preferred form the cantle 354 is provided as a flattened end rather than the usual raised cantle found to a standard saddle tree. At the pommel end 356 the pommel 356 can also be formed directly from the curved arms but is frequently attached thereto with known supporting means. The pommel 356 also includes two downwardly extending arms 356A that define an opening at the front of the tree and which is the basis of the tree gullet 315 and which opening is typically in the general shape of an curved inverted U. The inner surfaces of the pommel arms 356A are sometimes called the gullet plates.

Lying between the cantle 354, pommel 356 and the curved arms 358 is a hollow 352. The hollow 352 along with the gullet 315, in cooperation with the underlay 335 and raised cushions 390 define a channel that is a hollow space between the animal's spine and the under surface of the tree/underlay.

The inner surface of underlay 335 and which contacts directly with the horse in the present in the present illustration is shown as being a flat surface. However, many alternative surfaces are known in the art of saddlery in order to provide optimal comfort for the horse. These include raised dimple effects or even raised parallel ridges or ridges on oblique angles. More particularly the underlay includes the two additional cushions 390 that extend along the length of the underlay and which offer even more protection for the horse's spine and as discussed above in relation to how they assist to define the channel. The underlay 335 and cushions 390 are typically stuffed with a flock material known in the art and which can be wool, cotton, synthetic fibres or combinations thereof. In the use the cushions 390 can be opened up at either end to remove or add more flocking material as might be required for a particular horse. The underlay 335 is attached to the tree 350 on the tree's under surface and on the underlay's upper surface. The attachment can be done using methods known to those skilled in the art of saddlery.

The conditioning device 300 also includes two side panels 340 that attach directly to the upper surface of the tree frame 350 and across its entire length including the pommel 356, pommel arms 356A, cantle 354 and curved arms 358. The side panels 340 partially overlay the outer surface of the underlay 335 and facilitate the positioning of the receiving straps/belts 151 (not shown in FIG. 9) and which connect with the girth straps 150 and as described previously with respect to FIGS. 2 to 7. The receiving straps 151 can be secured between the side panels 340 and underlay 335. The girth assembly 120 is also substantially as previously described with reference to FIGS. 2 to 7. The side panels 340 which can be attached to the underlay 335 also provide additional positional stability of the underlay when the conditioning device 300 is in use.

The conditioning device 300 further includes an insert 360 that can be placed into the centre hollow 352 of the tree and which acts to provide a flat upper surface for the attachment of the compartment assembly 330. The insert 360 can be designed to fit snuggly fit into the hollow 352 of the tree without the need for additional securing or it can be directly secured in the hollow 352 and attached to the inner or surface of the tree frame 350 using methods known in the art. In an alternative arrangement the insert 360 can be replaced with a layer or multi-layered flap (not shown) which are preferably made of a thermo-moldable material which can be formed into a substantially flat surface for receiving the compartment 330. The flap arrangement extends from the pommel 356 to the cantle 354 and is secured at both ends and along the tree perimeter including the curved arms 358. The flap arrangement can be secured to the tree again using known saddlery techniques. The flap arrangement does not come in contact with the horses spine, and again preferably leaves a space between it and the horse” spine.

Optionally the conditioning device includes an overlay portion 365 that includes a centre section 365A having an upper surface adapted to sit atop the insert 360, or flap arrangement, and to provide a further stable flat surface for the compartment if required, and two side panels 365B which extend downwardly and overlap with the side panels 340. The overlay device can be directly secured to the side panels 340.

The conditioning device 300 further includes the compartment assembly 330. The compartment assembly 330 is provided as a substantially rectangular envelope shaped structure having on one side, and preferably the horses near side, an opening 335 for inserting a weight assembly 400, or 200 as discussed above in relation to FIGS. 7A, 7B and 8. The opening is closed by means of a flap 332 which preferably is hinged along the bottom long side edge of the compartment 330 and includes a zipper arrangement 336 along the perimeter of the flap with a counterpart zipper arrangement located on the compartment's edge adjacent the opening 335. For additional securing the flap 332 is provided with tabs 333 located at the distal ends of the flap and which have on their inner surface a securing arrangement 333A, such as Velcro® tape, and which engages with a counterpart securing arrangement located on the side panels 334 of the compartment. As with the conditioning device 100 discussed in FIGS. 7A and 7B alternative securing means are envisaged.

The compartment assembly shown in FIG. 9 is shown as being substantially rectangular in length and receiving just one weighted assembly 400. However, as with conditioning device 100 (FIGS. 2 to 8), it is envisaged that multiple weighted assemblies 400/200 and combinations of the various weighted assemblies will be used and that the compartment hollow also includes a plurality of defined spaces for receiving and securely holding therein the weight assembly(s) such that they do not move within the compartment hollow.

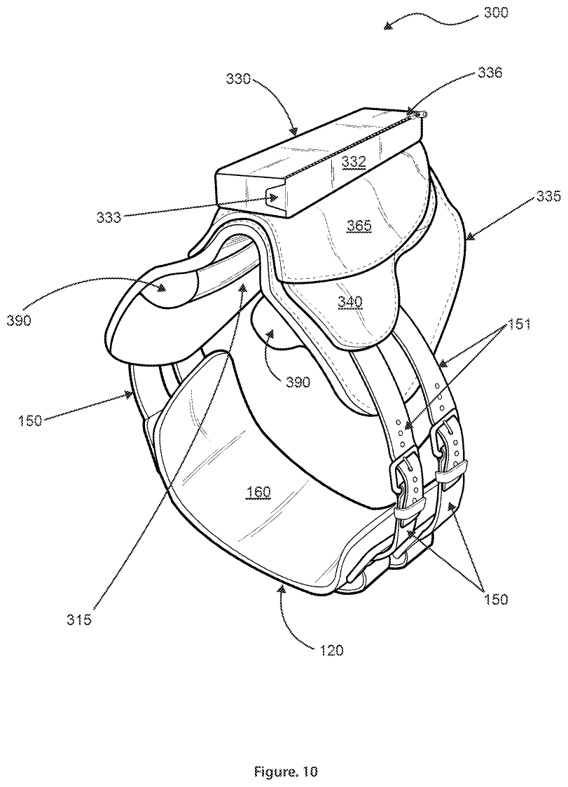

Turning to FIG. 10 the treed conditioning device 300 is shown from the front near side (that is the horses left side) perspective, however as it is in the constructed form the tree is not visible. The device includes a saddle portion 310 and girth assembly 120 (as per FIGS. 2 to 7) that co-operate with one another to define the invention for use on a horse. The girth assembly can be present in a variety of formats including a single girth strap, or two girth straps 150 as shown in the Figures, or possible three girth straps. In a further embodiment (not shown) it is possible to have a single girth strap having dual belt and buckle attachments at either end of the girth strap (that is two belt and buckle attachments) and which then attach to belts secured to the side panels. The receiving strap/belt sections 151 of the girth connecting arrangement found on the side panels can be of the usual saddle construction such as being leather stitched to a nylon webbing (not shown). In another form the girth straps can be attached to the side panels using a loop arrangement. In the present configuration the receiving strap/belt sections 151 are attached at a position between the underlay 335 and side panels 340.

More particularly the saddle portion 310 includes a tree frame as described above in relation to FIG. 9, to provide support and stabilise the device on the animal's back and allow a space over the horse's spine. Again, as discussed a saddle tree is traditionally made of a laminated wood and can include a reinforcing spring located along its length, although in the present instance as the conditioning device is not designed to carry a person the reinforcing spring may not be necessary. It may also include a plate riveted to the underside of the tree to help form the gullet 315 which is itself a void space formed between the animal's back and the apex point of the pommel 356.

The saddle arrangement of the conditioning device also has a gullet 315 which is defined by the tree (350, see FIG. 9) in cooperation with underlay 335 which is itself attached to the under surface of the tree, and the inner cushioning panels 390 which are preferably part of the underlay 335 itself, and not as separate cushions that are attached to the underlay. This arrangement allows the gullet 315 to clear the withers of the horse and this is achieved by the shape and formation of the gullet. The gullet shape being based on the overall shape of the pommel 356, the pommel arms 356A. This can be varied as with other treed saddles where the size of the gullet can be adapted to suit the individual animal.

As described in relation to FIG. 9 there are two side panels 340 which are attached to the tree and which extend downwardly such that they overlay the upper surface of the underlay. The side panels 340 can be attached to the underlay 335 if required, such as by stitching.

Also as described in relation to FIG. 9 in order to provide a flat surface for the compartment assembly 330 to sit on, in a generally horizontal plane, the inner hollow of the tree is either covered with a layer or multilayered flap arrangement or the insert 360. In order to ensure this surface is flat and even there is shown in place the optional overlay 365.

Located on the upper portion of the saddle arrangement 310, is a compartment assembly 330, which is preferably releasably secured to either the optional overlay 365 or flap arrangement and using releasable securing means such as Velcro®, male/female snap lock connectors, and stud connectors and where the respective cooperating/connecting parts are themselves secured to the bottom surface of the compartment assembly 330 and the overlay 365/flap arrangement. In FIG. 10 the compartment assembly is shown in its closed position with opening flap 332 secured by the perimeter zipper 336 and attachment tabs 333. The compartment includes an upper section, that is hollow (not shown in FIG. 3) and which is designed to receive a weight, and a support structure comprising two base supports 131. The base supports 131 stabilise the compartment on the upper section of the saddle. The base support structures 131 are located on the upper right and left hand sides of the saddle 110 and engage with the upper portion of the saddle side panels 140, and run along the horizontal length of the saddle.

The girth assembly 120 of FIG. 10 is substantially the same as described in FIGS. 2 to 7, and comprises girth straps 150 that extend from one side panel 340 to the opposing side panel 340 and are adapted to securely engage with the girth connecting arrangement receiving straps 151 and are tightened using a simple belt and buckle arrangement. In one embodiment the girth assembly 120 can be completely detachable from the saddle. In a further embodiment (not shown) the girth assembly 120 can be permanently fixed to just one of the side panels 340 preferably the far side panel (the horses right hand side) either via the saddle, the receiving straps 151 having one or a set of belt and buckle attachments or by other means such as stitching. Located at the mid-section of the girth assembly 120 there is provided an optional gusset support 160 that is designed to fit securely on the underbelly of the horse and prevents rubbing of the straps on the underbelly of the horse thus limiting irritation.

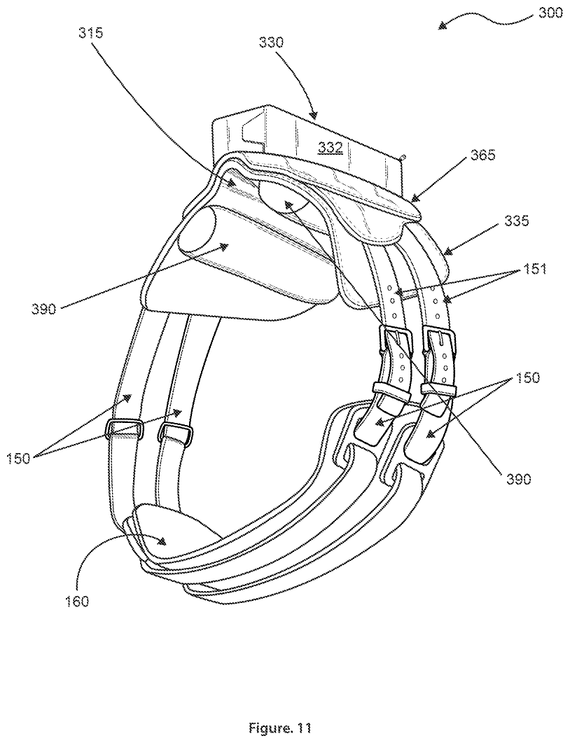

Turning to FIG. 11 there is shown a near side bottom perspective view of the conditioning device 300. FIG. 11 shows how cushions 390 run along the full length of the saddle arrangement and in cooperation with the tree and underlay define not only a gullet 315 but also a channel 320 that also runs the length of the saddle arrangement such that in use with the horse there is provided a hollow between the upper portion of the saddle including the tree and the horse's spine.

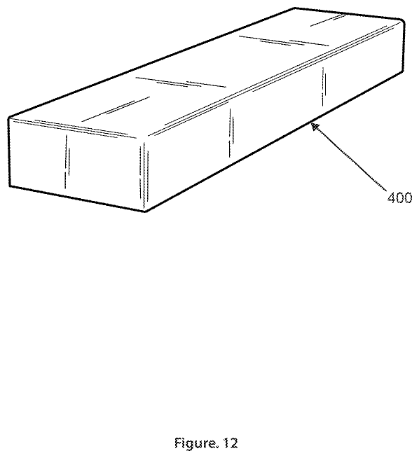

FIG. 12 shows an alternative example of a weighted assembly 400 for use with the compartment assembly 330. In its present configuration it is shown as a solid rectangular bar and which shape is designed to slide snuggly into and be secured in the inner space 335 of compartment assembly 330. As with the compartment assembly 130 described with respect to conditioning device 100 (FIGS. 2 to 8) various alternatives to both the inner space configuration and also the shape and form of weight assemblies are equally envisaged to be used with conditioning device 300 and the compartment assembly 330 is not to be limited to that described in the illustrated embodiment.

In relation to the conditioning device 300 described with reference to FIGS. 9 to 11 it is further envisaged that the additional features described with reference the conditioning device 100 of FIGS. 2 to 7A and 7B, such as O and D rings, crupper attachment points and the like will also be used with conditioning device 300.

It is envisaged that the entire conditioning device illustrated in the Figures can be constructed from a wide variety of materials including leather, composite materials such as high density polymers such as polyvinyl chlorides or polyester materials for the various panels, underlays and overlays and support base. These can be conveniently provided as durable double or triple layered materials where the outer layers provide a durable outer surface and the inner layer providing dimensional stability along with tensile strength. It is also possible for the core components of the device 100 such as the side panels, girth straps and even the support bases to be made of leather. A composite device comprising both leather and synthetic materials is also envisaged. In relation to the tree it can be made from traditional materials such as wood and wood laminates but it is envisaged that alternate materials such as fibreglass, composite plastics even carbon fibre could be used.

The conditioning device as illustrated in the Figures and described herein can be assembled using techniques known in the art of saddle making and saddlery embodiments.

Further features envisaged for use with the device of the invention include monitoring systems to track the animal's physiological responses such as respiratory rate and heart beat. Other devices for measuring respiratory conditioning, skin surface biochemical detectors, pressure sensors and potentially neuromuscular detectors may also be incorporated into the device of the invention as described above. These devices may further include Bluetooth capabilities for rapid data collection and transfer and subsequent data analysis for comparative studies and development of tailored training regimes, such as those described below.

Conditioning of an Animal

### EXAMPLE 1

### Preliminary Trialling

The device of the invention and the embodiments thereof described above is designed to aid in the training and conditioning of an animal, and preferably a horse, with an aim to improve the animal's physical condition and particularly its epaxial strength.

Whilst not necessarily required it is believed that the animal, and preferably a horse, will benefit most if it is already pre-educated to accept reins, surcingles and even more preferably a saddle on its back. Equally when the device of the invention is to be used on a horse during lunging, it is important the horse be acclimated to the lunging process so that the horse will work calmly and in submission. If the horse is inverting during lunging, initial work without the invention should be undertaken by an experienced trainer. When a horse “inverts” its back, it raises its head, tenses its back muscles and fails to use core muscles correctly. An inverted horse does not engage the strong epaxial muscles along its spine and therefore does not stabilize its spine. This failure to stabilize the spine results in incorrect biomechanical pressures on the joints of the back, directly leading to intervertebral osteoarthritis, overriding dorsal spinous processes and desmitis. In order to train the horses back and core muscles correctly, the horse must elevate its neck and back while bringing the head closer to a vertical position. This results in flexion of the vertebral column, engagement of the epaxial and abdominal muscles, the core muscles of the horse, and development of athletic strength through the back of the horse. When allowed to travel with a head high position, the horse uses incorrect muscles, resulting in improper biomechanical forces and resultant injury.

The steps proposed for conditioning an animal, and preferably a horse may include the following:
(i) The horse is assessed by the trainer and its conditioning status determined. This guides the selection of both the requisite weight to be used and what potential exercise regime it can be put through.
(ii) Based on the preliminary analysis undertaken in Step (i) a sufficient volume of weight (such as water) is inserted into the weight assembly and the weight assembly placed in the weight compartment and secured therein.
   (iiA) Based on the preliminary analysis and results from steps (i) and (ii) it is possible to vary the application of the weight in both the type of container, as well as what weight to use including using solid weights or the weights being loaded in the different sub-compartments of the weigh assemblies.
(iii) The conditioning device is then placed on the horse's back and secured in place with the girth assembly the same as with any saddle.
(iv) Any extraneous devices are then attached to the horse as required, such as heart rate monitors
(v) The horse is then allowed to experience and adapt to the saddle and the various weights within the weight compartment. This time is variable and dependent on the horse and will be assessed by the trainer.
(vi) Once the horse has acclimatised to the device it is hand walked for 5 to 10 minutes. The horse can also be worked at trot for 5-10 minutes either by hand, lunged or ponied. The horse may be rested during work as needed.
(vii) Once the horse has rested or has adapted and is comfortable with the conditioning device it can then be put through a series of simple further movements including walking in smaller circles, backing and turning on its haunches. It can also be lunged if showing the correct submission and side reins or sliding side reins can be utilized. At this point further variation in the type of containers and type of weights can then be selected.
(viii) It is important to monitor not only obvious physiological parameters but also take note of any muscular development especially in the horse's abdomen, rump and topline.

Once the animal (horse) has become conditioned to the device, and particularly at the lowest weight, further exercise regimes can be trialled such as merely extending the time frame or gradually increasing the weight level, then extending the time frame. It is important that during all of the exercises the horse is encouraged to maintain submission and is not allowed to invert during exercise. This may be counterproductive to the purpose of the method and application of the conditioning device.

Further advanced exercise regimes can include the following.

### EXAMPLE 2

### Advanced Use—Trotting, Cantering, Lunging

(i) Steps (i) to (v) of Example 1 are repeated with the animal until the animal has acclimatised to the device
(ii) The experienced horse or one that has acclimatized to the conditioning device can with time be put through more advanced drills.
(iii) Once the horse has accepted the device further weight can be added incrementally and the horse can then be put through simple trotting exercises. It is envisaged that at the start the trot will be limited to a small time frame in the order of 2 to 3 minutes which can then be increased to sessions of up to 5 minutes. During this time the horse is continually monitored visually for signs of stress and also preferably through the monitoring of physiological measurements, such as respiration and heart rate.
(iv) Once the horse is adapted to trotting with the invention, cantering actions can be introduced, starting at a minimum time of 1 to 2 minutes. length of canter work can gradually be increased as the horse adapts and strengthens.
(v) Furthermore, advanced methods such as using the device and putting the horse through gentle caveltti or ground pole training is yet another method.

### EXAMPLE 3

### Advanced Use: Lunging

(i) Steps (i) to (v) of Example 1 are repeated with the animal until the animal has acclimatised to the device
(ii) The horse, with the conditioning device attached, can then be put through standard lunging exercises. When engaging in lunging exercises the conditioning device is connected via suitable reins to a bit and bridle arrangement. Importantly the horse must be previously used to lunging and must accept lunging and side reins and running reins in a calm and quiet manner. Horses that are prone to kicking, racing or bucking on the lunge are not suitable to using the conditioning device with lunging until these issues are controlled.
(iii) If employing the lunge it is important that the horse moves with a degree of submission and willingness and has an engaged back, and does not lift its head nor invert its back.
(iv) Lunging exercises can be continued for periods of up to 30-45 mins according to the horse's level of fitness. Equally the weight being carried can gradually be increased depending on the size and temperament of the horse.

While there have been described what are believed to be preferred arrangements of the invention, it will be appreciated by those skilled in the art that other and further modifications may be made to both the device and methods of use thereof without departing from the spirit of the invention, and it is intended to claim all such changes and modifications as fall within the scope of the invention.

It is apparent from the above, that the device and method of uses thereof are applicable to use in the animal husbandry industry and particularly the equine training industry.

1. A conditioning device for use with an animal to improve the animal's physical well-being and develop physical strength the device comprising a saddle arrangement for positioning on the back of said animal and a girth assembly for securing the saddle arrangement on the animal;
wherein the saddle arrangement includes:
(i) a weight-bearing seat portion,
(ii) two side panels affixed to the seat portion wherein the panels extend downwardly from the seat portion base such that the panels lie substantially along the sides of the animal;
(iii) a compartment assembly located on top of the seat portion , wherein the compartment assembly includes an inner space adapted to receive and releasably hold therein at least one removable weight assembly;
and having at least one girth connecting arrangement attached to the seat portion, and;
and wherein the girth assembly includes:
at least one strap adapted to engage with the girth connecting arrangement and adapted to secure the entire arrangement on the animal.

2-44. (canceled)
